(19) United States
(12) Patent Application Publication
(10) Pub. No.: US 2022/0096876 A1
(43) Pub. Date: Mar. 31, 2022

(54) Respiratory Mask

(71) Applicant: 3D PRINTER EXPERIENCE CORPORATION, Chicago, IL (US)

(72) Inventors: Christopher James Dalton, Chicago, IL (US); Christopher Martinez, Chicago, IL (US)

(21) Appl. No.: 17/037,229

(22) Filed: Sep. 29, 2020

(51) Int. Cl. A62B 18/02; A41D 13/11; A62B 23/02; A62B 18/08

(52) U.S. Cl. CPC A62B 18/025; A62B 18/084; A62B 23/02; A41D 13/1161

(57) ABSTRACT

A respiratory mask is disclosed having a body adapted to fit over at least the nose and mouth of a person to form a breathable air space. The body has a nose and mouth opening and a filter opening. The filter opening is in front of the nose and mouth opening.

### FIELD OF THE INVENTION

This invention relates in general to respiratory masks.

### BACKGROUND OF THE INVENTION

Masks have been used to cover a wearer's face and to filter air available to the wearer.

The present inventor recognized the need for a respiratory mask with a centrally located filter. The present inventor recognized the need for a mask that has a reusable body. The present inventor recognized the need for a mask useable with a replaceable filter. The present inventor recognized the need for a mask that filters air entering the mask and air exiting the mask when worn.

### SUMMARY OF THE INVENTION

A respiratory mask is disclosed comprising a body adapted to fit over at least the nose and mouth of a person to form a breathable air space. The body comprises a nose and mouth opening and a filter opening. The filter opening is in front of the nose and mouth opening.

In some embodiments, the nose and mouth opening is horizontally aligned with the filter opening and the filter opening is laterally central to the body of the mask. The body is configured to create an air tight seal with the wearer's face when properly deployed. In some embodiments, the body comprises a gasket for engaging with the user's face about the nose and mouth opening.

In some embodiments, the mask comprises a filter and a cover. The filter covers the filter opening and the cover removably secures the filter to the body.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a left perspective view of an embodiment of the respiratory mask of the invention.

FIG. 2 is a right perspective view of the mask of FIG. 1.

FIG. 3 is a front view of the mask of FIG. 1.

FIG. 4 is a left side perspective exploded view of the mask of FIG. 1.

FIG. 5 is a left side perspective view of a portion of the body of the mask of FIG. 1.

FIG. 6A is a left side perspective view of a portion of a cover of the mask of FIG. 1.

FIG. 6B is a left side section view of the mask of FIG. 1 taken along the plane 7-7 of FIG. 3.

FIG. 6C is a front view of a second embodiment cover usable with the mask of FIG. 1.

FIG. 6D is a left side view of the cover of FIG. 6.

FIG. 7 is a rear view of the mask of FIG. 1.

FIG. 8 is a bottom perspective view of the mask of FIG. 1.

FIG. 9 is a left perspective view of the mask of FIG. 1 and a gasket shown exploded from the mask.

FIG. 10 is a front view of the mask and gasket of FIG. 9.

FIG. 11 is a rear view of the mask and gasket of FIG. 10 with the gasket shown transparently.

FIG. 12 is an enlarged side view of a gasket post of the body of the mask of FIG. 1.

FIG. 13 is a front view of a post aperture of the gasket of FIG. 9.

FIG. 14 is a left side view of the mask of FIG. 1 shown on a face of a model person.

FIG. 15 is a front view of the mask and model person of FIG. 14.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, this description describes and the drawings show specific embodiments of the invention with the understanding that the present disclosure is to be considered as an exemplification of the principles of the invention and is not intended to limit the invention to the specific embodiments illustrated.

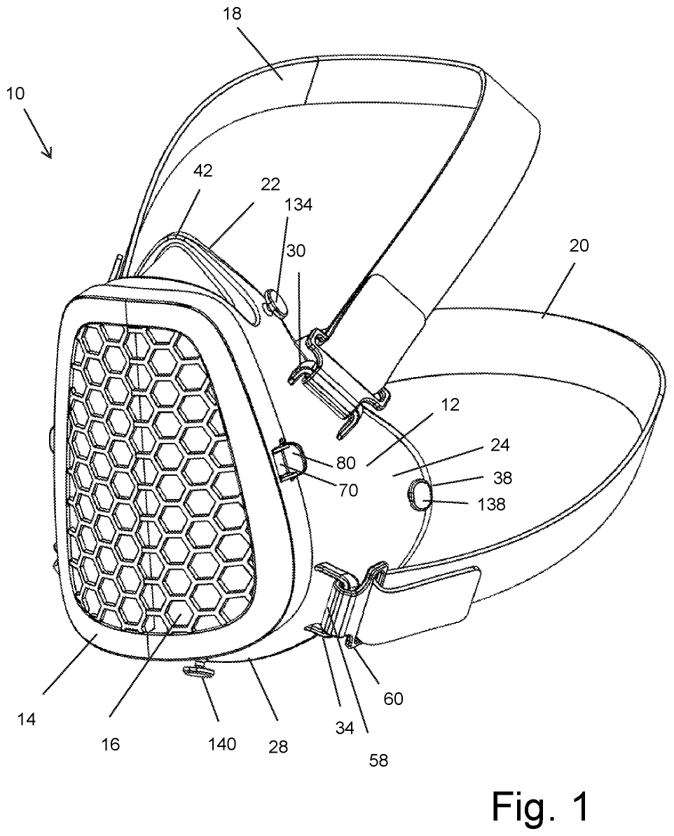

FIG. 1 shows one embodiment of a respiratory mask 10 of the invention. The mask comprises a body 12, a front cover 14, and a filter 16. The body when worn by a wearer/person creates a breathable air area for a wearer. In some embodiments, the mask comprises a first strap 18 and a second strap 20.

The body 12 is shaped to cover the nose and mouth of the wearer. The body is shaped to cover at least a portion of the face of a wearer. In some embodiments, the mask is shaped to cover portions of the face of a wearer over a portion of the mandible bone, a portion of the maxilla bones, and a portion of the nasal bones.

The body comprises an upper nasal portion 22, opposite lateral side portions 24, 26, and a bottom portion 28. The body widens from the nasal portion 22 to the opposite lateral side portions. The body narrows from the opposite lateral side portions to the bottom portion.

The exterior side of the body comprises strap anchors 30, 32, 34, 36. The upper strap anchors 30, 32 are located between the widest portions 38, 40 of the lateral side portions 24, 26 and the apex 42 of the nasal portion 22. The lower strap anchors 34, 36 are located between widest portions 38 and 40 and the middle 44 of the bottom portion 28. In some embodiments, the strap anchors comprise an inverted U-shape as shown in the figures. Opposite ends of each strap comprise hooks 50, 52, 54, 56 that adjustably and removably join the straps to the respective anchors 30, 32, 34, 36. Each of the hooks 50, 52, 54, 56 are the same. In some embodiments, each of the hooks comprises a hook portion 58 joined to a strap loop 60.

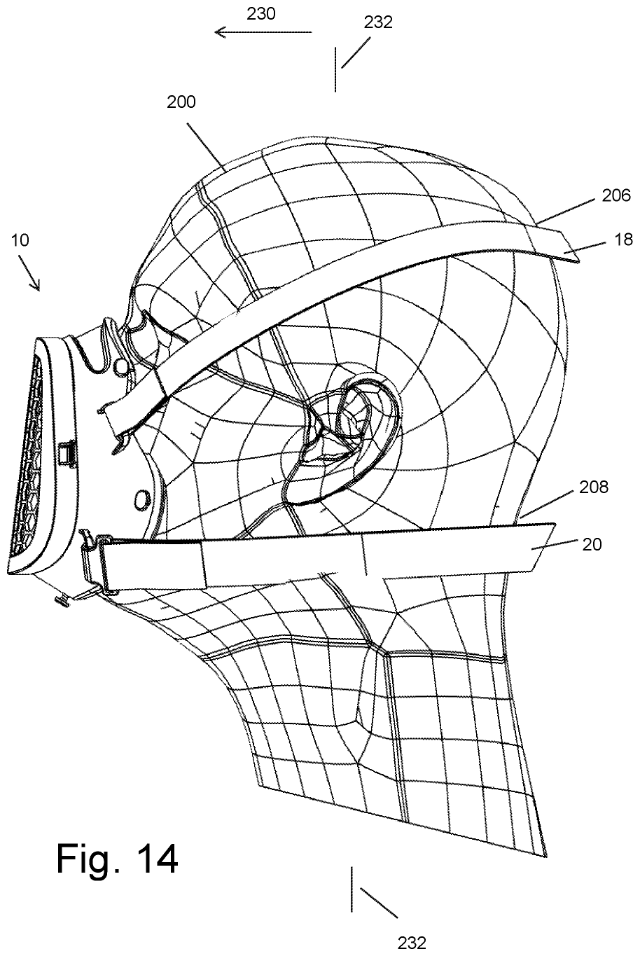

In some embodiments, the hook portion 58 comprises a U-shape or J-shape, with one end of the U or J joined to the loop 60, the internal space of the U or J for receiving the corresponding anchor for joining thereto. The straps extend through the strap loops of the respective hooks. In some embodiments, one or more hooks may not be used and the straps may be fixed directly the anchors such as shown at the top anchors in FIG. 14.

The nasal portion 22 may comprise a nose support 62 which is recessed from the surrounding portion of the body to engage with a top area of the wearer's nose.

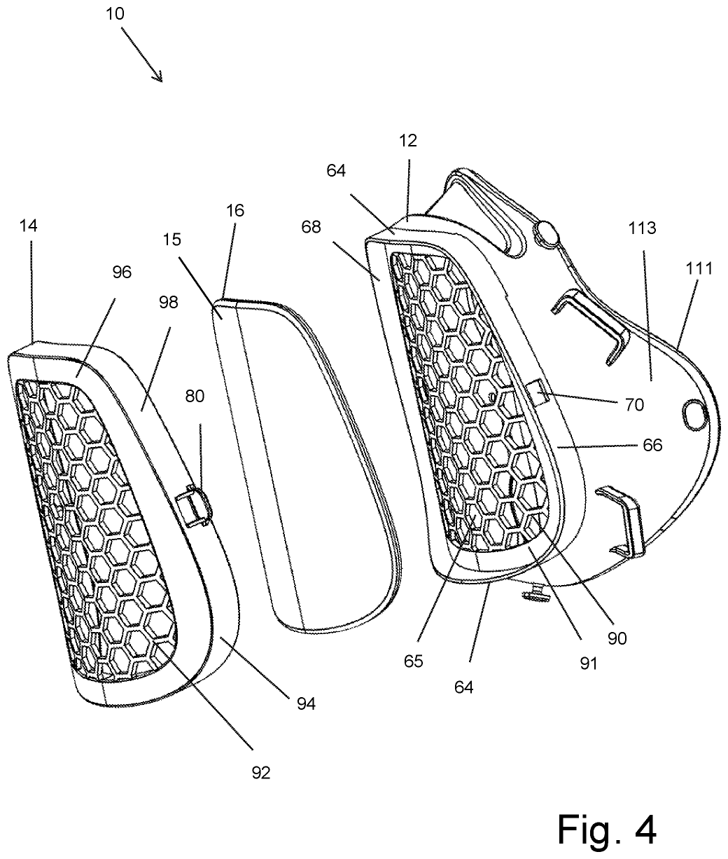

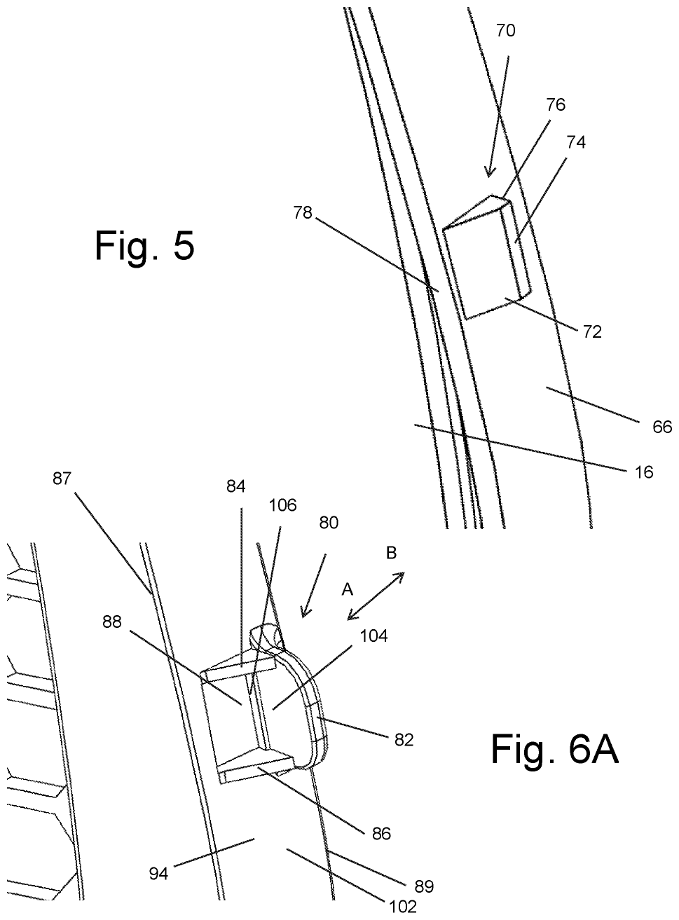

FIG. 4 shows an exploded view of the mask. The front of the body comprises a filter opening 65 and a filter lip 64. In some embodiments, an internal grate 90 is located in the filter opening 65.

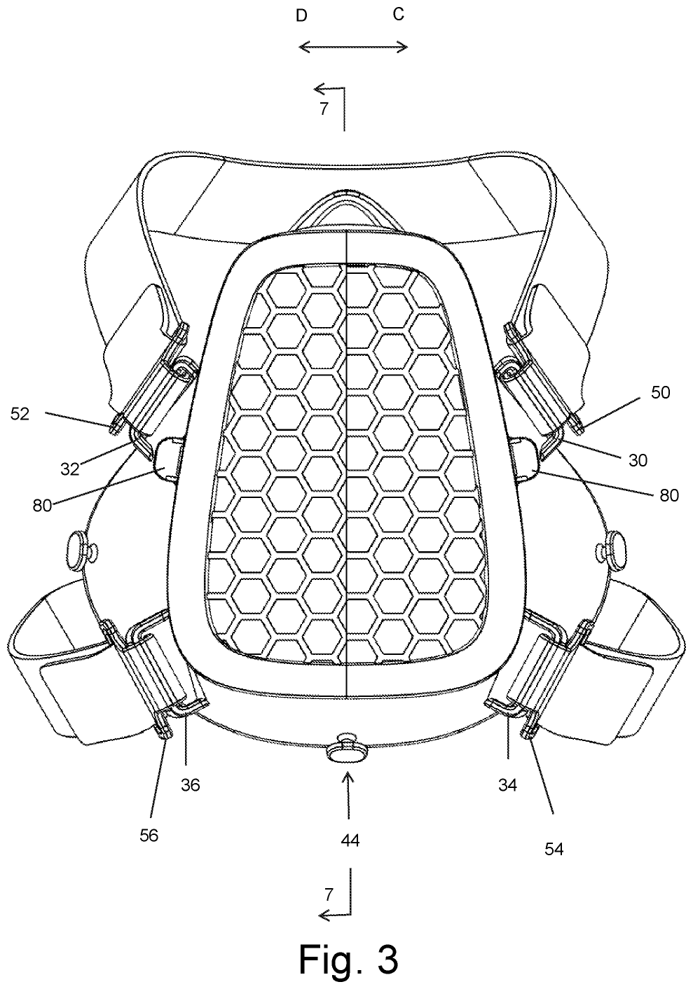

The filter opening 65 is laterally (directions C/D) central to the mask 10. The filter 16 and the cover 14 are also laterally central to the mask 10. In some embodiments, the mask is symmetric about a central sagittal plane 7-7 (FIG. 3) bisecting the mask, and in such cases the filter opening, filter, and is laterally equidistantly located between the widest portions 38, 40 of the lateral side portions 24, 26 of the body. In some embodiments, the filter opening, the filter, and the cover extend along substantially the entire vertical height of the body as shown in FIG. 3, with small portions extending above and below the filter opening.

Opposite sides 66, 68 of the filter lip 64 comprise retaining blocks 70. Each retaining block comprises an incline ramp 72 adjacent the front edge 78 of the filter lip 64, a plateau 74, and a retaining wall 76. The ramp connects to the plateau. The plateau joins to the retaining wall 76. In some embodiments, the plateau joins with the retaining wall at a right angle. The filter lip 64 provides a surface for the filter 16 to rest between an internal grate 90 of the body 12 and a cover grate 92 of the cover. The internal grate 90 is located within the filter lip of the body. Therefore, when the cover is mounted to the body, the filter 16 is supported on the filter lip between the cover grate 92 and/or the internal grate 90. The filter covers the filter opening and filters the air passing through the filter, at least from the external side 113 of the mask to the internal side 117.

Between the internal grate 90 and the filter lip 64 is a facing perimeter 91, which surrounds the internal grate 90. In some embodiments, the facing perimeter 91 has a height between the internal grate 90 and the filter lip 64 of 6 millimeters. In some embodiments, the filter opening comprises a height of about 93 millimeters, or 93.3 millimeters, and a widest width of 94 millimeters. In some embodiments, the width of the filter opening is wider at the bottom of the filter opening than at the top of the filter opening.

The cover 14 comprises an edge lip 94, front perimeter 96, and the cover grate 92. The front perimeter surrounds the grate 92. The edge lip extends transverse from the front perimeter to extend behind the front perimeter. The edge lip overlaps, and in some embodiments, is in surface to surface contact with the filter lip of the body when the cover is mounted to the body. Opposite sides 98, 100 of the edge lip 94 each comprise clips 80 for engaging with the respective retaining blocks 70. Each of the clips 80 are mirror image identical about the central sagittal plane 7-7 of FIG. 3, so only one of the clips 80 will be described in detail.

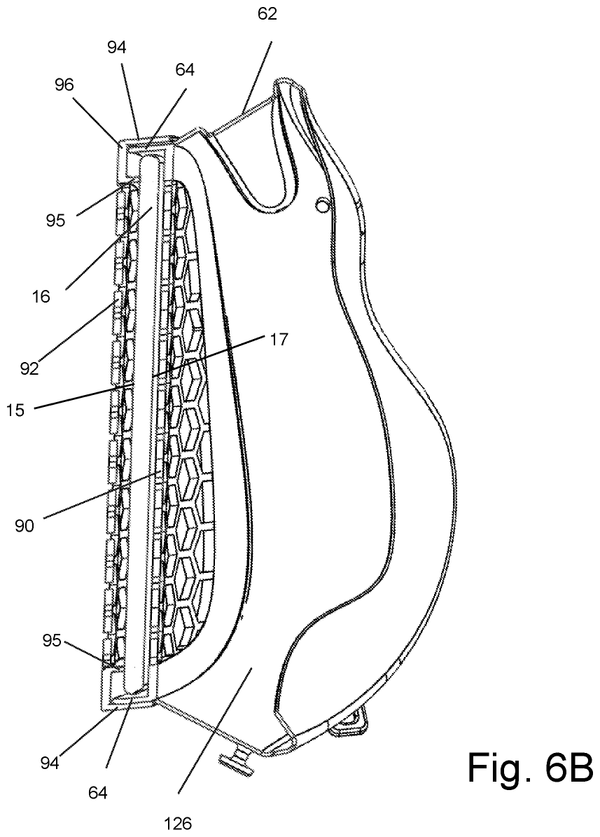

FIG. 6A shows the clip 80 in more detail. The clip comprises an aperture 88 between front and rear edges 87, 89 of the edge lip 94. The clip comprises a handle wall 82 adjacent the aperture 88 opposite the front edge 87. The clip comprises angled upper and lower sidewalls 84, 86 on opposite sides of the aperture 88. The upper and lower side walls angle away from the main surface 102 of the edge lip 94 toward the handle wall 82. The handle wall 82 extends higher than the highest portion of the upper and lower walls 84, 86. The perimeter edge of the handle wall 82 may be curved as shown in FIG. 6.

The front 104 of handle wall 82 blocks the cover from further motion in the forward direction A away from the body, by contact with the retaining wall 76. In some embodiments, the front 104 of the handle wall 82 is in contact with the retaining wall 76 when the cover is mounted to the body.

To remove the cover from the body, a user pulls the handle wall 82 in the direction A away from the body to cause the edge lip to flex outward in the direction C or D (FIG. 3), depending on the selected clip. When the edge lip is flex sufficiently so that the bottom most portion 104 of the handle wall 82 is above the plateau 74, the cover can be removed in the direction A away from the body.

To mount the cover to the body, the clips 80 are aligned with the retaining blocks 70. The cover is moved in the direction B toward the body. The edge lip 94 at the clip is flexed outward in the direction (C or D) away from the filter lip by the ramp 72 until the edge lip 94 at the clip meets the plateau 74. Once the front 104 of the handle wall 82 passes the retaining wall 76, the resilience of the edge lip 94 will pull the edge lip 94 inward toward the filter lip and the retaining block 70 will be located within the aperture 88 of the clip 80 to secure the cover on the filter lip and the body. The front 104 of the handle wall 82 will be behind the retaining wall 76.

The cover grate 92 and the internal grate 90 each comprise a hexagonal grid, however other grid configurations can be used, such as square, rectangle, triangle, circle, and/or oval.

FIG. 6B shows a side section view of the mask. The internal lip 95 extends transverse from the front perimeter 96 opposite the edge lip 94. The internal lip 95 may contact the filter 16 about the perimeter of the filter to further secure it against the facing perimeter 91 and/or internal grate 90 of the body.

FIGS. 6C and 6D show a second embodiment cover 97 that is the same as cover 14, except cover 97 comprises a different cover grate 99. The second embodiment cover 97 is usable with the body 12 in place of cover 14. The second embodiment cover 97 is mounted and dismounted to the body in the same manner as cover 14. The grate 99 comprises slats or louvers 101 and a central post 103. The post intersects the louvers. The louvers 101 comprise a downward angle from a back 105 of the louver to a front 107 of the louver. The downward angle of the louvers directs any aerosolized droplets from the user exhaling downward to minimize its spread to others, if such aerosolized droplets are not caught in the filter 16. Gaps 109 are located between the louvers to allow air to pass between the louvers.

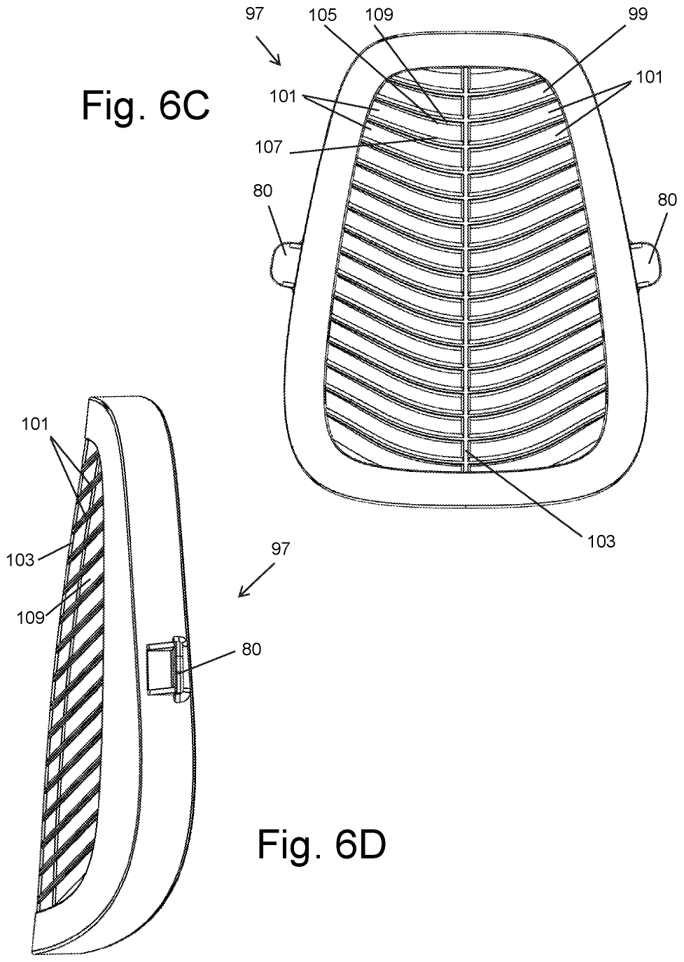

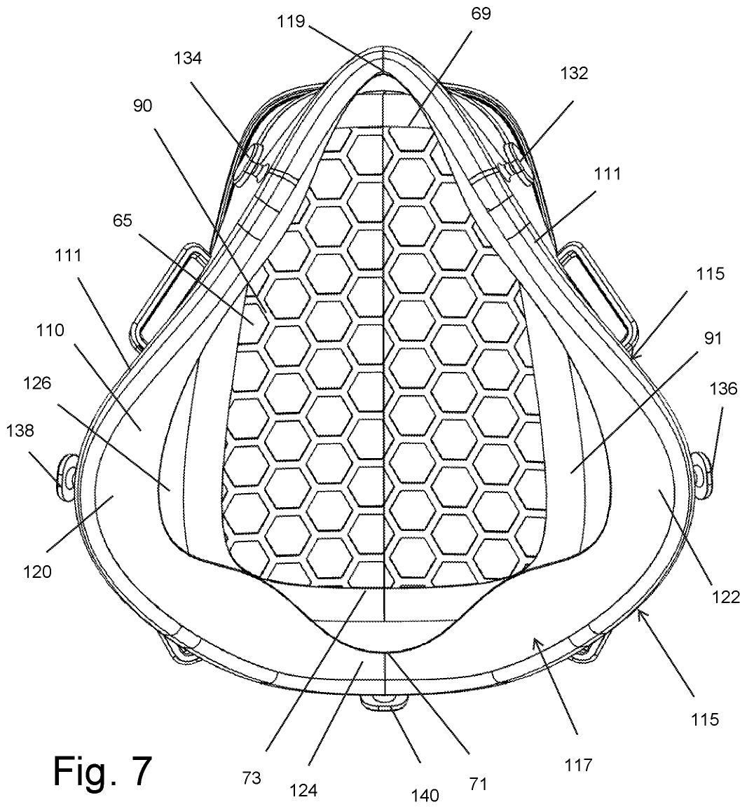

FIGS. 7 and 8 shows the back of the mask. The back of the mask comprises a face side opening, and more particularly, a nose and mouth opening 115. The perimeter of the mask comprises and edge 111 surrounding the nose and mouth opening and an internal lip 110 extending from the edge 111.

FIG. 7 shows that in some embodiments at least a portion, and in some cases a majority or substantially all, of the filter opening 65 and filter 16 is horizontally aligned with the nose and mouth opening, as shown in FIG. 7. In some embodiments, at least a portion, and in some cases a majority or substantially all, of the filter opening 65 and the filter 16 is vertically aligned with the nose and mouth opening 115, as shown in FIG. 7.

In some embodiments, the interior apex 119 of the nose and mouth opening 115 is located above the top 69 of the filter opening 65. Further, the top 71 of the of the internal lip 110 at the bottom is below the bottom 73 of the filter opening.

The nose and mouth opening is laterally wider than the filter opening in a mouth portion of the nose and mouth opening, and the nose and mouth opening is laterally narrower than the filter opening in a nose portion of the nose and mouth opening, as shown in FIG. 7.

The internal lip 110 is configured to conform to a wearer's face. The lip comprises left and right nose portions 112, 114 for covering the nose of a wearer, left and right cheek portions 116, 118 for covering portions of the cheeks of a wearer, left and right mouth edge adjacent portions 120, 122 for covering portions of the face adjacent the mouth of a wearer, and a chin portion 124 for covering at least a portion of the chin of a wearer. In some embodiments the internal lip 110 and/or edge 111 is configured to contact the corresponding portion of a wearer's face to create an air tight seal around the wears nose and mouth.

In some embodiments, the inner lip may be comprised of a flexible material, such as rubber, foam, silicone, neoprene, or memory foam, or a combination thereof.

The internal grate 90 is spaced apart from the internal lip 110 and/or edge 111 to form an internal space 126. The internal space accommodates at least the wearer's nose and mouth. The internal space provides an internal gas space for breathable air. The nose and mouth opening 115 is closed by the face of a person wearing the mask to close the internal gas space on the face side of the mask. The edge 111 and/or the internal lip 110 contacts the face of the wearer, at least about the wearer's nose and mouth to close the internal gas space on the face side of the mask. Breathable air is preferably located within the internal gas space.

When worn by a person, the mask is sealed to the person's face at the internal lip and/or edge 111 around at least the user's nose and mouth. The straps, when properly adjusted, draw the mask against the wearer's face to create an air-tight seal. The wearing persons' inhaling respiration causes a negative pressure within the internal space 126, causing exterior air to be drawn through the filter 16 into the internal space to equalize the pressure within the mask to the pressure outside of the mask or move the negative pressure within the internal space closer to the pressure outside of the mask. Depending on the filter used in the mask the filter filters out airbone particles and droplets] in the process of the air passing through the filter. The person's exhaling respiration causes a positive pressure within the internal space 126, causing some air within the internal space to be expelled through the filter from the mask to equalize or move the positive pressure closer within the internal space to the pressure outside of the mask. Therefore, the mask can filter air entering the internal space of the mask. And the mask can filter air exiting the mask through the filter, particularly during exhalation of the wearer.

Various filters can be used with the mask 10 depending on the intended application of use and the requirements thereof. In some embodiments, the filter filters airborne debris, aerosolized droplets, and the like. In some embodiments, the filter meets the N95 standard and therefore filters out of the air at least 95 percent of airborne particles. In some embodiments, the N95 standard is the standard set by the U.S. National Institute for Occupational Safety and Health, which may be currently found at 42 C.F.R 84. In some embodiments, the filter protects against airborne solids, liquids, oils, and/or metal fumes.

The cover holds 14 the filter 16 against the facing perimeter 91 and/or the internal grate 90 so that all of the air that passes through the filter opening is filtered by the filter, including air from outside of the mask to the internal space 126 and air from the internal space 126 to outside of the mask.

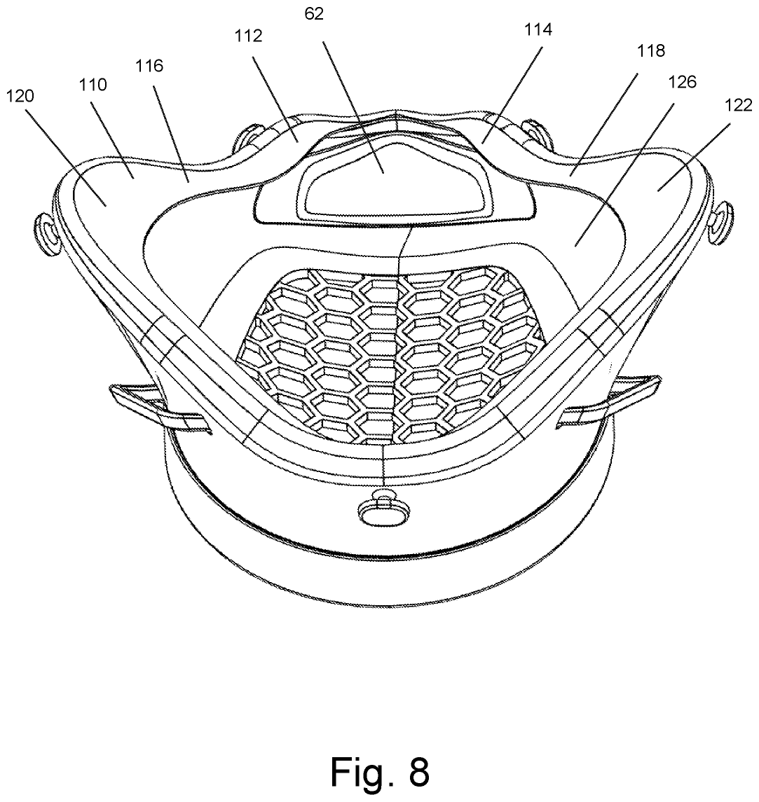

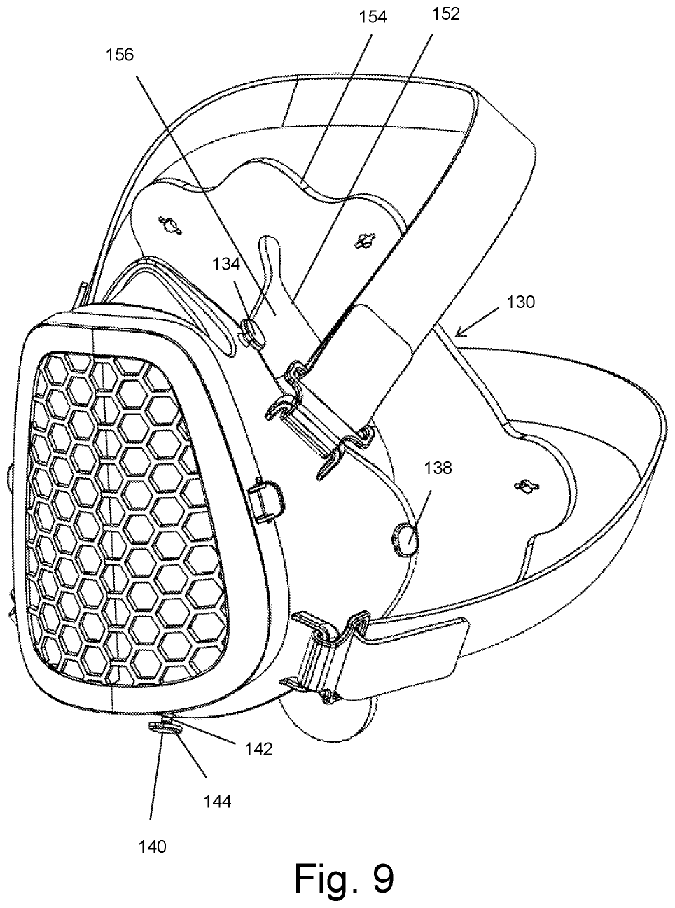

In some embodiments, the mask comprises a gasket 130 shown in FIGS. 9 to 11. The gasket is shown exploded from the mask and in a flat configuration. In some embodiments, the body 12 of the mask 10 comprises gasket posts 132, 134, 136, 138, 140. The posts are spaced apart about the exterior perimeter of the body adjacent the edge 111. There are two posts 132, 134 on opposite sides of the apex in the nasal portion 22. There are two posts on opposite sides of the lateral side portions 24, 26. There is a post 140 at the bottom of the bottom portion 28.

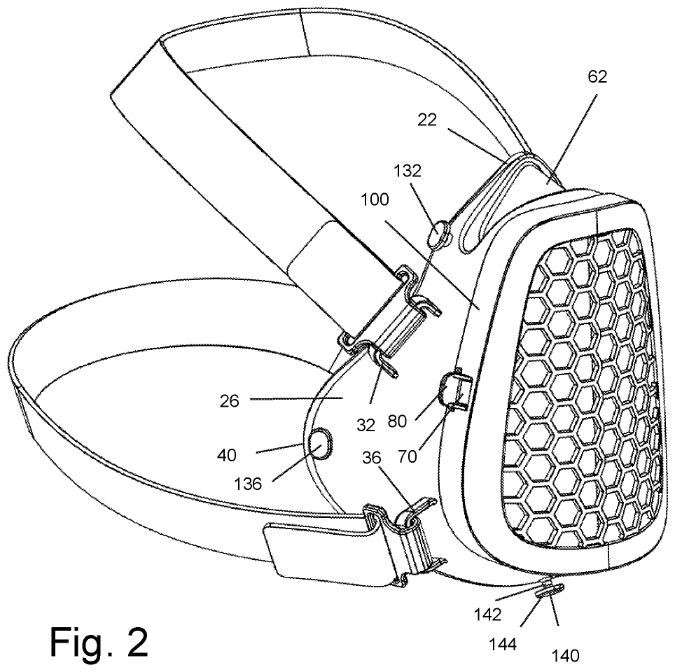

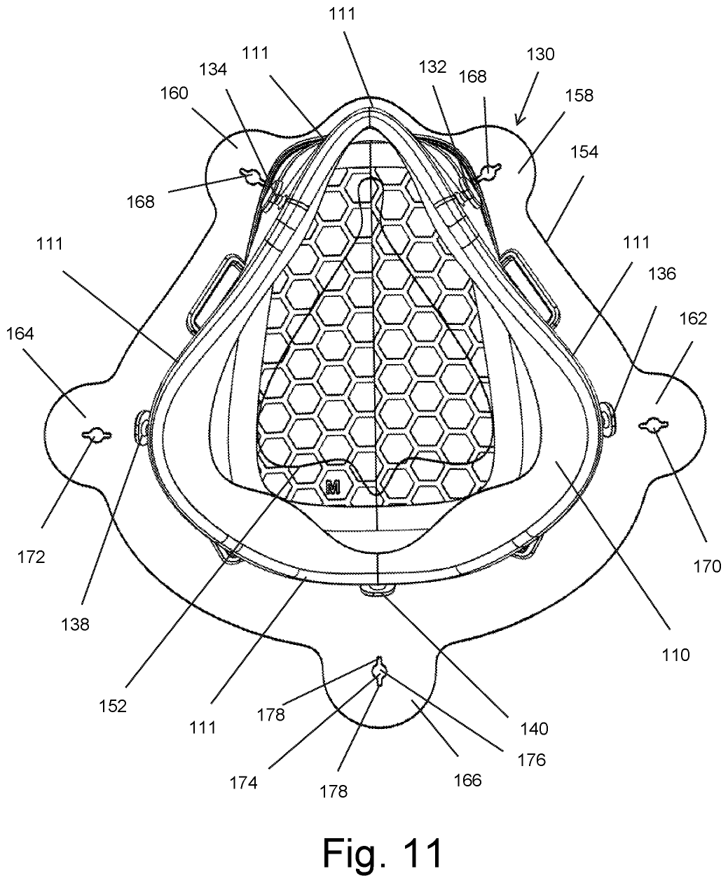

As shown in the figures and labeled in FIGS. 2, 9, and 12 for post 140, each post comprises a shaft 142 and a head 144. The shaft joins the head to the main surface 117 of the body 12 and spaces the head from the main surface. The head has a larger diameter or width than the shaft.

The gasket comprises a generally similar profile to that of the mask as shown in FIGS. 9-11. The gasket is sized to overlay the edge 111 between the inner lip 110 and the exterior side 113 of the mask, and at least a portion of the inner lip 110. The gasket 130 comprises an interior boundary 152 and an exterior perimeter 154. The interior boundary 152 defines an interior opening 156. The gasket comprises protruding regions 158, 160, 162, 164, 166 about the exterior perimeter at each of post apertures 168, 169, 170, 172, 174. The protruding regions provide additional material about the post apertures, providing additional material strength in those regions. The protruding regions 158, 160, 162, 164, 166 and the post apertures 168, 169, 170, 172, 174 are located about the gasket to align with the respective gasket posts 132, 134, 136, 138, 140.

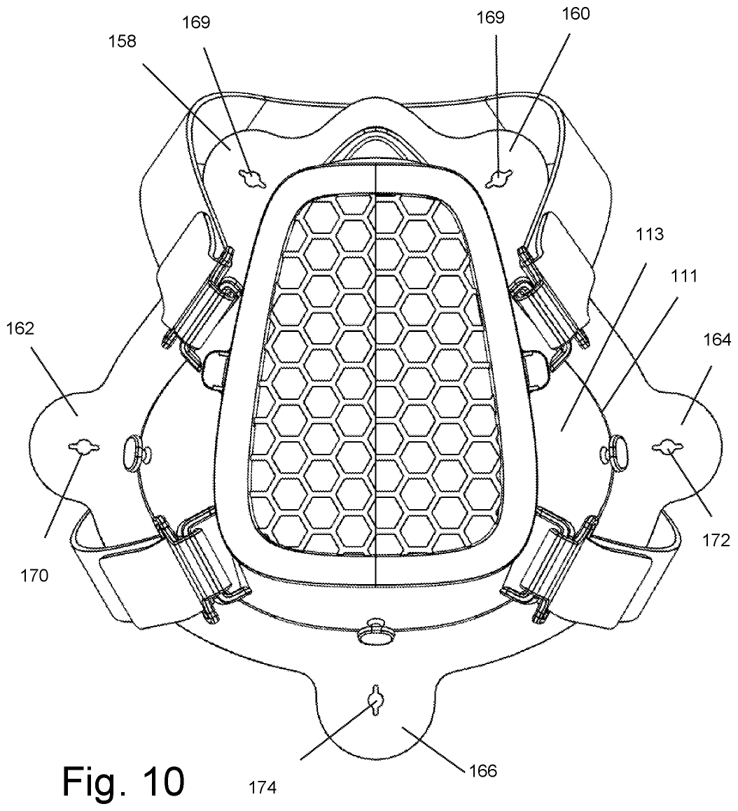

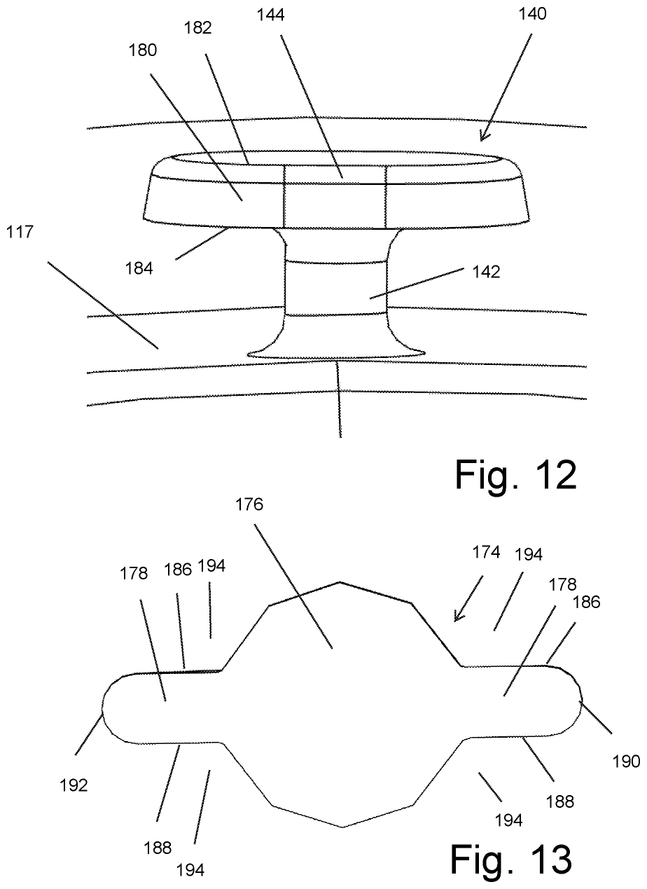

As labeled in FIGS. 11 and 13 for post aperture 174, each of the post apertures comprise a main opening 176 and opposite slotted openings 178. The slotted openings are sized to allow the head of the gasket post to pass through the post aperture from a lateral direction so that the height of the side 180 of the head, between a top 182 and a bottom 184 of the head, is aligned with the slotted openings 178. The first side 186 of each slotted opening is opposite of the second side 188. The distance between the first and second side 186, 188 is sufficient to receive the height of the side 180 of the head. The first end 190 of one of the slotted openings is opposite of the side end of the second end 192 of the second opening.

The distance between the first and second ends 190, 192 is sufficient to receive the width or circumference of the head 144.

When the head 144 passes through the slotted openings 178, the shaft 142 is received into the main opening 176. The circumference of the head 144 is larger than the main opening 176. Therefore, the head retains the gasket under the head, and overlaps areas 194 adjacent the main opening, until the gasket is twisted or moved to align the side 180 of the head with the slotted openings 178. The gasket can be rotated or twisted to align the slotted openings with the side 180 of the head to mount or remove the gasket from the corresponding gasket post.

The gasket can provide additional sealing for enabling and/or enhancing an airtight seal of the mask to the wearer's face. When the gasket is mounted to the mounting posts, it is folded over the edge 111 to cover the inner lip 110 of the mask. Therefore, when worn by a wearer the seal extends to the edge 111 to ensure a seal. In some embodiments, the gasket is sized to cover the entire inner lip 110 and edge 111 of the mask. In some embodiments, the mask is made of or comprises rubber.

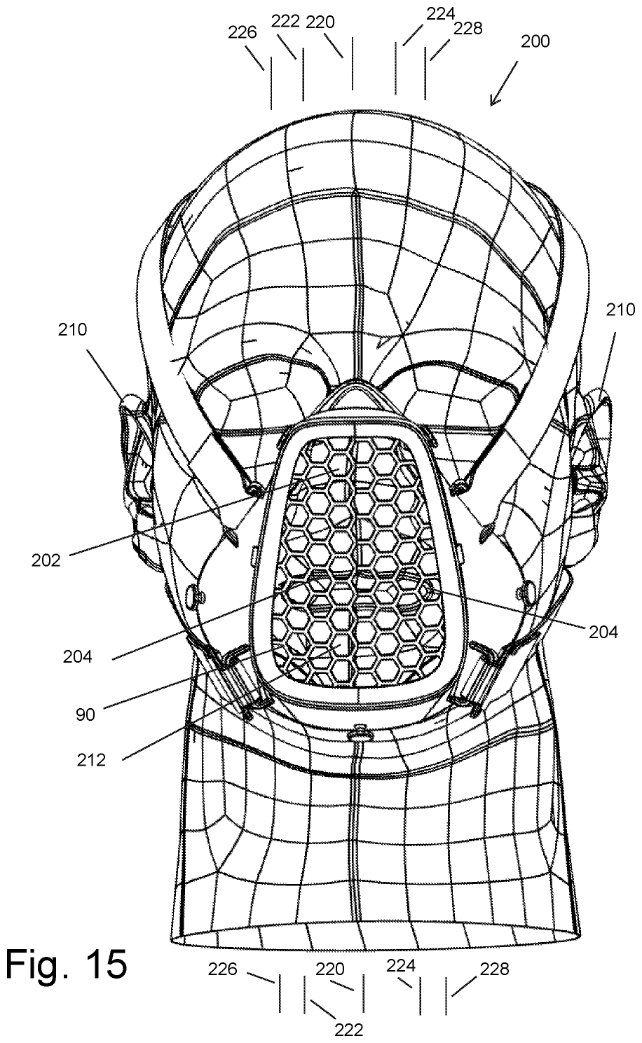

FIGS. 14 and 15 show the mask deployed on a person/wearer 200. The mask in FIG. 15 is shown without a cover or a filter, so the wearer's nose 202 and mouth 204 are visible through the internal grate 90. The grate 90, filter opening 65, and filter 16 are centrally located on the mask. When the mask is worn by the wearer, the filter 16, filter opening 65, and the cover 14 and the internal grate 90 is located in front of the wearer's nose 202 and mouth 204. In some embodiments, the grate and filter are also located in front of the wearer's chin 212.

The location of the mask relative to the wearer can be described with reference to standard anatomical terms of location with the person/wearer in the human standard anatomical position. The grate and filter are forward of the wearer's nose and mouth at least in the median plane or mid-sagittal plane 220 of the wearer. The mid-sagittal plane bi-sects head and the body into two halves (left and right sides). The forward direction 230 can be relative to the central or mid coronal plane 232 (shown approximately in FIG. 14) that divides the body into posterior (back) and anterior (front) portions. The mid-sagittal plane is perpendicular to the mid coronal plane.

The filter opening 65, internal grate, and filter have a width so the filter opening, internal grate and filter are located forward of the wear's nose and mouth in a number of para-sagittal planes, positioned on either side of the mid-sagittal plane, such as parasagittal planes 222, 224, 226, 228, as shown in FIG. 15.

The upper strap 18 can be deployed by the wearer 200 around the wearer's head in the crown area 206 of the head. The lower strap 20 can be deployed around the wearer's back of the neck or lower rear 208 of the head. The straps can extend above and below the wearer's ears 210. This upper and lower deployment of the straps on the wearer can assist in properly sealing the mask to the wearer's face.

The mask is reusable. In some embodiments, the mask, other than the filter and the straps, is made of a plastic or rubber material, which can be washable and sanitizeable. The body comprises air and liquid impermeable exterior walls for preventing the same from passing from an exterior to an interior of the mask, other than through the filter opening. In some embodiments, the straps comprises elastic materials that allow the straps to stretch out to a longer length and withdraw to a unextended position.

In some embodiments, the filter 16 is a 5N11 N95 Particulate Filter made and/or sold by 3M Company having an address at 3M Center, St. Paul, Minn., USA]. The filter is disposable and replaceable by removing the cover, removing the existing filter, and replacing it with a new filter, and then replacing the cover on the body. In some embodiments the filter 14 has a height of 99.3 millimeters and a widest width of about 100 millimeters. In some embodiments, the width of the filter is wider at the bottom of the filter than at the top of the filter. In some embodiments the filter has a height that is greater than its width. In some embodiments, the filer has a surface area on at least one side, such as the front side 15 and/or the back side 17, anywhere in the range of 67 centimeters² to 101 centimeters², inclusive of the end values.

In some embodiments, the filter opening provides the only exit pathway from the internal space 126 to outside of the mask when the mask is worn by a wearer. Therefore, in some embodiments, the mask does not have a separate exhalation opening, path, or valve, separate from the filter opening that also receives and filters incoming air. In such an embodiment, the filter opening acts as an air inlet and an air outlet from the internal space 126 of the mask. Therefore, the filter at and covering the filter opening filters air entering the internal space and air exiting the internal space out of the mask. This provide air filtering protection to the wearer as well as air filtering protection to other persons and places adjacent the wearer. Filtering of the exhaled air exiting the mask through the filter opening protects other persons and places from particles, droplets, bacteria, and/or viruses that might be expelled by the wearer during respiration, in particular, exhalation, or talking.

In some embodiments, the body and cover are manufactured by using 3D printer to form the body and cover out of plastic. In some embodiments, the body and cover are manufactured by injection molding the body and cover out of plastic.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. Further, steps could be added or removed from the processes described. Therefore, other embodiments and implementations are within the scope of the invention.

The invention claimed is:

1. A respiratory mask, comprising:
a body comprising a nose and mouth opening and a filter opening, the filter opening is in front of the nose and mouth opening and laterally central to the body; and,
a cover attached to the body at the filter opening.

2. The mask of claim 1, wherein at least a portion of the nose and mouth opening is horizontally aligned with the filter opening.

3. The mask of claim 2 wherein at least a portion of the nose and mouth opening is vertically aligned with the filter opening.

4. The mask of claim 1, comprising a filter located at the filter opening behind the cover, and wherein the filter opening is an air inlet and an air outlet.

5. The mask of claim 4, wherein the filter opening comprises a first grate, the cover opening comprising a second grate, the filter located between the first grate and the second grate.

6. The mask of claim 1, wherein the cover comprises downward angled louvers.

7. The mask of claim 1, wherein the body comprises a retaining block and the cover comprises at least one clip releasably engageable with the retaining block to join the cover to the body.

8. The mask of claim 7 wherein the clip comprises an aperture and a handle, the handle adjacent the aperture, and the aperture sized to receive the retaining block.

9. The mask of claim 1, comprising a gasket sized cover an edge of the body about the nose and mouth opening.

10. The mask of claim 1, wherein the body comprises a plurality of gasket posts adjacent the nose and mouth opening.

11. The mask of claim 1, wherein the body comprises a plurality of strap anchors.

12. The mask of claim 1, comprising one or more straps connected to the body for holding the body to the face of a person.

13. The mask of claim 1, the body comprising a boundary about the nose and mouth opening for engaging the face of a person.

14. The mask of claim 1, wherein the nose and mouth opening is laterally wider than the filter opening in a mouth portion of the nose and mouth opening; the nose and mouth opening is laterally narrower than the filter opening in a nose portion of the nose and mouth opening.

15. The mask of claim 1, wherein the filter opening extends along substantially an entire vertical height of the body.

16. A respiratory mask, comprising
a body adapted to fit over at least the nose and mouth of a person and form a breathable air space, the body comprising a nose and mouth opening and a filter opening, the filter opening is in front of the nose and mouth opening, at least a portion of the nose and mouth opening is horizontally aligned with the filter opening.

17. The mask of claim 17 wherein at least a portion of the nose and mouth opening is vertically aligned with the filter opening.

18. The mask of claim 16, comprising a filter located at the filter opening.

19. The mask of claim 19, comprising a cover removably attachable to the body at the filter opening, the filter opening comprises a first grate, the cover opening a second grate, the filter located between the first grate and the second grate.

20. A respiratory mask, comprising
a body adapted to fit over at least the nose and mouth of a person and form a breathable air space, the body comprising a face-side opening and a filter opening, the filter opening is in front of the face-side opening, at least a portion of the face-side opening is horizontally aligned and vertically aligned with the filter opening.
